(19) United States
(12) Patent Application Publication
(10) Pub. No.: US 2008/0189780 A1
(43) Pub. Date: Aug. 7, 2008

(54) METHOD AND SYSTEM FOR PREVENTING UNAUTHORIZED ACCESS TO A NETWORK

(76) Inventor: Noriaki Hashimoto, Kawaguchi (JP)

Correspondence Address: WATCHSTONE P+D, PLC, 1250 CONNECTICUT AVENUE, N.W., SUITE 700, WASHINGTON, DC, 20036-2657, US

(21) Appl. No.: 11/841,403

(22) Filed: Aug. 20, 2007

Related U.S. Application Data
(63) Continuation of application No. 09/690,818, filed on Oct. 18, 2000, now abandoned.

(51) Int. Cl. G06F 9/00; G06F 15/16

(52) U.S. Cl. 726/11

(57) ABSTRACT

A method and system for preventing an unauthorized access to a network via a user computer. The system includes a memory containing an IP address of the user computer and a microprocessor. The microprocessor is programmed to terminate a connection between the user computer and the network when an originating IP address of a data packet received from the user computer does not match the IP address of the user computer contained in the memory. The method uses a user computer connected to a network and an access control system. It includes storing an IP address of the user computer in a memory of the access control system, receiving a data packet from the user computer, and comparing an originating IP address of the data packet with the IP address of the user computer stored in the memory. The method further includes denying the user computer an access to the network if the originating IP address of the data packet is different from the IP address of the user computer stored in the memory.

### BACKGROUND OF THE INVENTION

1. Field of the Invention

The present invention relates to a method and system for preventing an unauthorized access to a network. The invention uses a plurality of systems and software to protect a network from an unauthorized access.

2. Discussion of the Related Art

The Internet has experienced, and will continue to experiences an explosive growth. The Internet was originally designed to provide a means for communicating information between public institutions such as universities. However, with the development and provision of user friendly tools for accessing the Internet, the public at large is increasingly turning to the Internet as a source of information and as a means for communicating information. Furthermore, both consumers and companies are turning to the Internet as a means for conducting a variety of financial transactions.

The Internet's success is based partly on the openness of its protocols: TCP (Transmission Control Protocol) and IP (Internet Protocol) Internet protocols operate by breaking up a data stream into data packets. Each data packet includes a data portion and address information. The IP is responsible for transmitting the data packets from the sender to the receiver over a most efficient route. The TCP is responsible for flow management and for ensuring that packet information is correct. Details of the two protocols are available to the public and are known to those skilled in the art.

As the popularity of the Internet grows, so has the number of malicious acts committed over the Internet. More recently, malicious acts committed over the Internet have caused major disruptions in daily lives of those who rely on the Internet. For example. there have been a number of widely reported malicious acts over the Internet based on computer viruses including the Melissa and Explore.zip viruses and the “I Love You” worm. These viruses spread over computer networks worldwide in a matter of days via the Internet and have caused millions of dollars in damages. Besides computer viruses, the Internet has been used to launch denial of service attacks against popular web sites and vandalize home pages of private and public institutions.

Despite serious economic damages caused by malicious acts over the Internet, efforts by business and government institutions to detect and prevent such acts have not been very effective. This is partly due to the difficulty in tracing identities of those who commit malicious acts over the Internet. In fact, it is widely accepted that one with a moderate amount of technical knowledge and experience relating to the Internet can defeat various measures placed by private and government institutions to detect and prevent malicious acts. For example, it is often difficult to identify individual responsible for committing malicious acts because they can hide their identities relatively easily by altering transmission logs. In fact, they can alter transmission logs to make an innocent party appear responsible for his or her acts.

The ease of altering identities over the Internet facilitates a commission of a malicious act that is difficult, if not impossible, to trace to a responsible party. It is not difficult for one to learn necessary workings of the Internet to commit such untraceable act, since the Internet is based on the premise that protocols and mechanisms used to run it should be available to all. In other words, unlike in the real world, it is much easier for one to learn and control an environment to escape detection. For example, without leaving one's own desk, one can destroy evidence by manipulating and altering various parts of the Internet. Specifically, one can hide his or her identity by altering transmission logs, altering IP addresses of data packets, or launching malicious acts from a computer that belongs to another. Thus, to prevent untraceable malicious acts and to capture those responsible for such acts, it is important to prevent alteration of identities over the Internet.

Given this relative ease of committing untraceable malicious acts and the difficulty in capturing those responsible for them, it becomes increasingly important to prevent malicious acts over the Internet from becoming untraceable. The best way to do so is to prevent those who commit untraceable malicious acts from connecting to the Internet. In particular, it is important to prevent an access to the Internet by those who try to mask their identities by altering an originating IP address of a data packet that they send. Thus, there is a need for providing a system and method for preventing an unauthorized access to the Internet or a network by blocking a data packet with an inaccurate or altered IP address information in order to increase overall network security.

### SUMMARY OF THE INVENTION

Accordingly, the present invention is directed to a method and system for preventing an unauthorized access to a network. Specifically, the present invention is directed to a method and system for preventing access to a network when an originating IP address of a data packet receive from a computer does not match the IP address assigned to that computer.

To achieve these and other advantages and in accordance with the purpose of the present invention, as embodied and broadly described, an access control system for preventing, an unauthorized access to a computer via a user computer connected to the network includes a memory and a microprocessor. The memory contains an IP address assigned to the user computer. The microprocessor is programmed to terminate a connection between the user computer and the network when an originating IP address of a data packet received from the user computer does not match the IP address assigned to the user computer that is contained in the memory.

In another aspect, the invention includes an access control system for preventing an unauthorized access to a network via a user computer connected to the network through a host computer system. The access control system has a memory aid a microprocessor and is located between the user computer and the host computer system. The memory contains an IP address assigned to the user computer. The microprocessor is programmed to terminate a connection between the user computer and the host computer system when an originating IP address of a data packet received from the user computer does not match the IP address assigned to the user computer contained in the memory.

In another aspect, the invention includes a method for preventing an unauthorized access to a network via a user computer that is connected to the network and to an access control system. The method includes storing an P address of the user computer in a memory of the access control system and receiving a data packet from the user computer. It further includes comparing an originating IP address of the data packet with the IP address of the user computer stored in the memory of the access control system and denying, the user computer an access to the network if the originating IP address of the data packet is different from the IP address of the user computer stored in the memory of the access control system.

In yet another aspect, the invention includes a method for preventing an unauthorized access to a network via a user computer connected to the network through a host computer system that is connected to an access control system. The method includes storing an IP address of the user computer in a memory of the access control system and receiving a data packet from the user computer. It further includes comparing an originating IP, address of the data packet with the IP address of the user computer in the memory of the access control system and terminating a connection between the user computer and the host computer system if the originating IP address of the data packet is different from the IP address of the user computer stored in the memory of the access control system.

In a further aspect, the invention includes a secure network including a host computer system connected to the secure network, an access control system connecting to the host computer system, and a user computer connected to the host computer system. The user computer is capable of accessing the secure network through the host computer system. The access control system has a memory that contains an IP address of the user computer. It is programmed to terminate a connection between the host computer system and the user computer when an originating IP address of a data packet sent from the user computer for transmission to a node in the secure network does not match the IP address of the user computer contained in its memory.

In another aspect, the invention includes a secure network that includes a user computer connected to the secure network and an access control system. The access control system has a memory that contains an IP address of the user computer. It is programmed to deny the user computer an access to the secure network when an originating IP address of a data packet sent from the user computer for transmission to a node in the secure network does not match the IP address of the user computer contained in its memory.

Finally the invention also includes an access control system for preventing an unauthorized access to a network via a user computer connected to the network. The access control system includes a memory and a comparator structure. The memory contains an IP address of the user computer. The comparator structure is capable of terminating a connection between the user computer and the network when an originating IP address of a data packet received from the user computer does not match the IP address assigned to the user computer that is contained in the memory.

Additional features and advantages of the invention will be set forth in the description, which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention. In the drawings;

FIG. 1 is a diagram of one embodiment of a secure network using access control systems of the present invention;

FIG. 2 is a diagram of a second embodiment of a secure network using access control systems of the present invention;

FIG. 3 is a diagram of a third embodiment of a secure network using access control systems of the present invention;

FIG. 4 is a diagram of an embodiment of an access control system of the present invention;

FIG. 5 is a flow chart depicting an embodiment of one aspect of an operation performed by an access control system of the present invention; and

FIG. 6 is a diagram of a alternative embodiment of an access control system of the present invention.

### DETAILED DESCRIPTION OF THE PREFERRED EMBODIMENTS

Reference will now be made in detail to the preferred embodiments of the present invention, examples of which are illustrated in the accompanying drawings.

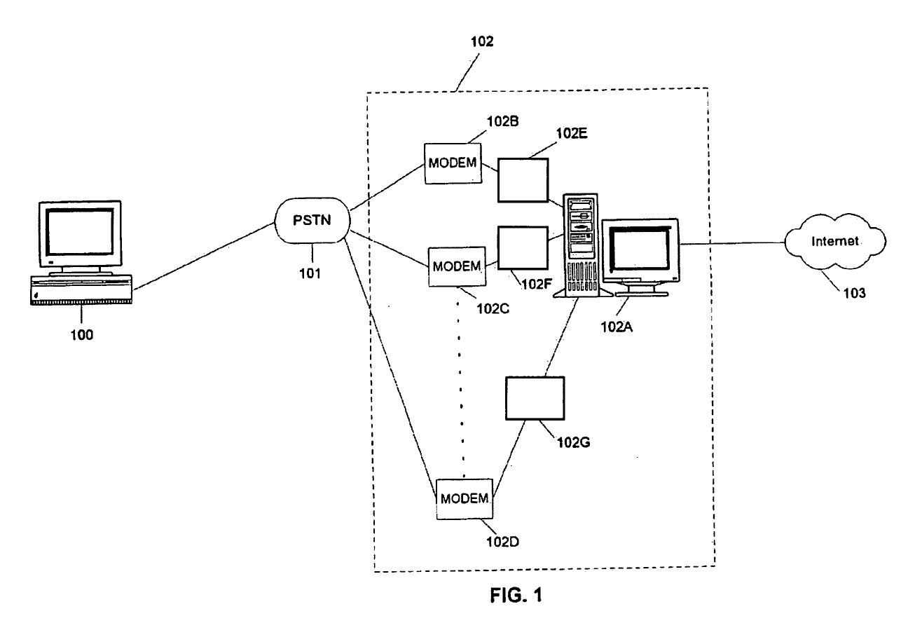

With reference to FIG. 1, one embodiment of a secure network using access control systems of the present invention includes a user computer 100 connected to a host computer system 102 via Public Switched Telephone Network (PSTN) 101. The user computer 100 accesses the Internet 103 via the host computer system 102. An Internet service provider typically operates the host computer system 102. The host computer system 102 comprises a plurality of modems (102B, 102C, and 102D)) a plurality of access control systems (102E, 102F, and 102G), and an access server 102A.

An access control system is typically located within or close to the host computer system 102 so that a user has no physical access to it Moreover, it is preferable that a user has no remote access to an access control system. FIG. 1 shows the plurality of access control systems (102E, 102F, arid 102G) installed between the plurality of modems (102B, 102C, and 102D) and the access server 102A. While FIG. 1 shows one access control system per one modem, one access control system may be connected to more than one modem. Alternatively, one modern may be connected to more than one access control system. Further, the access control systems (102E, 102F and 102G) may be installed within each of the modems (102B, 102C, and 102D) of the host computer system 102 either as hardware or software. One or in ore access control systems may also be installed within the access server 102A either as hardware or software.

The host computer system 102 typically assigns one of the modems connected to the access server 102A to the user computer 100. For example, the user computer 100 might access the Internet 103 using the modem 102B. Then, the access control system 102E would contain the IP address assigned to the user computer 100 and would monitor data packets sent from the user computer 100. When the stored IP address does not match an originating IP address of a data packet received from the user computer 100 via the modem 102B, the access control system 102E would terminate the connection between the user computer 100 and the host computer system 102. In other words, the user computer 100 would no longer be able to access the Internet 103. To resume sending data packets to the Internet 103, the user computer would have to reestablish a connection, for example, by logging onto the host computer system 102.

The access control systems 1( )2E, 102F, and 102G may terminate the connection between the user computer 100 and the host computer system 102 by electrically cutting off the connection between them or by filtering out data packets sent from the user computer 100. Alternatively, they may issue commands to an appropriate modem or the access server 102A, so that either the modem or the access server 102A would terminate the connection between the user computer 100 and the host computer system 102. Other methods of terminating the connection between the user computer 100 and the host computer system 102 would be known to those skilled in the art and are within the scope of this invention.

FIG. 4 depicts one embodiment of an access control system 400 that is implemented with separate hardware. As started previously, an access control system may also be implemented by software. When implemented by software, it may run on a separate hardware, a user computer, a host computer system, or other peripherals used to access the Internet such as a modem or a hub, Further, while FIG. 4 depicts a memory 400A and a microprocessor 400B as two separate components, this separation is not required. For example, one may use an internal memory of the microprocessor 400B instead of a separate memory.

In FIG. 4, the access control system 400 is connected to a user computer 401 and a host computer system 402 via network cables 403 and 404. The access control system 400 has the memory 400A and the microprocessor 4008. The memory 400A contains an IP address assigned to the user computer 4013 if any. The microprocessor 4008 is programmed so that it compares an originating IP address of a data packet received from the user computer 401 with the IP address of the user computer stored in the memory 400A. The access control system 400 discards the data packet, if the two IP addresses are not the same, or if its memory does not contain any address information of the user computer 401. It also causes the connection between the user computer 401 and the host computer system 402 to terminate. Upon the termination of the connection between the user computer 401 and the host computer system 402, the IP address of the user computer 401 may be deleted from the memory 400A. If an IP address to the user computer 401 is dynamically assigned, the memory 400A is updated when a new IP address is assigned to the user computer 401. If the user computer 401 has a permanent IP address, the memory 400A contains that address.

While the FIG. 4 shows the access control system 400 with two network connections 403 and 404, it may have more than two connections. In any case, it is preferable that the access control system supports various types of networks such as Ethernet (IEEE 802.3) and a serial network (RS-232C). Furthermore, the access control system may be programmed so that it is equipped with additional filtering capabilities to allow filtering of data packets based on a factor other than an originating IP address. It would be desirable to program the access control system so that its filtering parameters may be altered in real time and/or remotely.

Typically, an IP address is assigned to the user computer 401 by the host computer system 402 when the connection between the user computer 401 and the host computer system 402 is established. Protocols used to establish the connection between the two computers include Serial Line Internet Protocol (SLIP), Point-to-Point Protocol (PPP), and any other protocols that are used for dial-up connections. Additional protocols include Dynamic Host Configuration Protocol (DHCP), which may be used when the host computer system 402 functions as a DHCP server in a local area network.

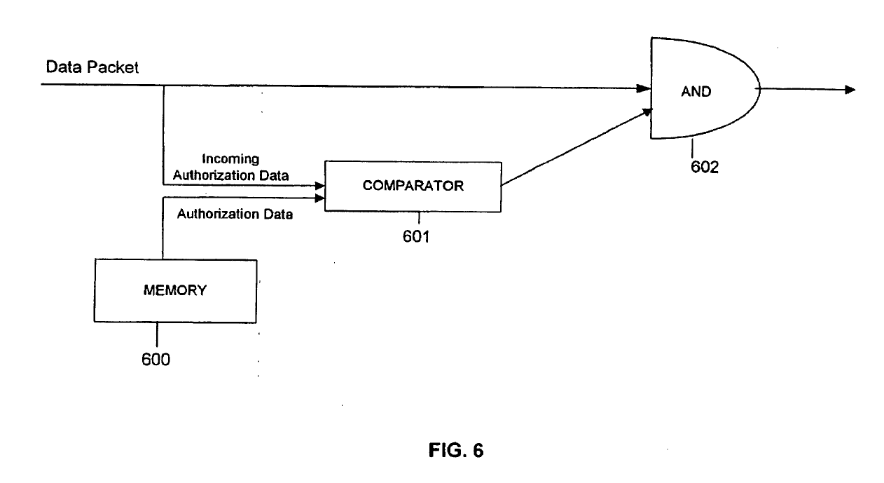

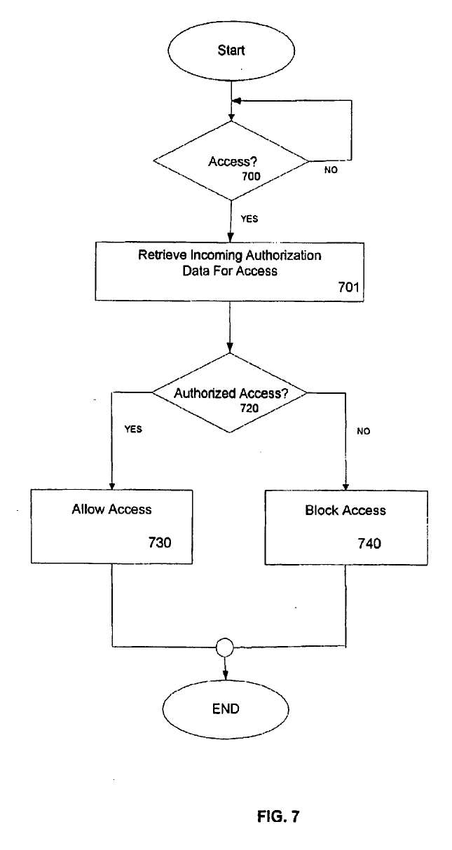

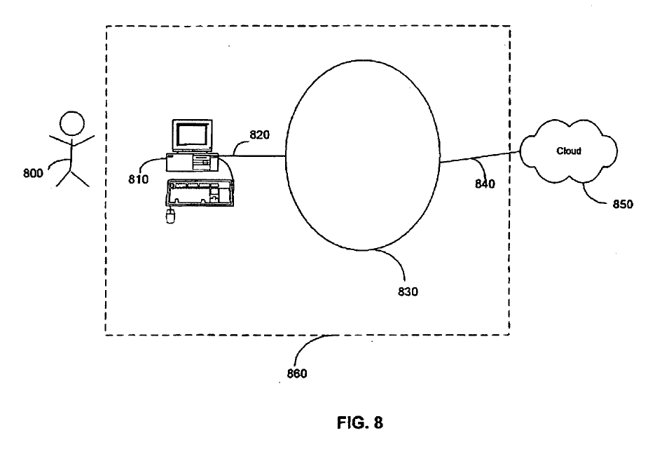

FIG. 6 shows another embodiment of an access control system of the present invention. Under this implementation, the access control system comprises a memory 600 and a comparator structure with a comparator 602 and an AND gate 602. The memory 600 contains IP addresses of one or more user computers connected to the access control system. When the access control system receives a data packet from a user computer, the comparator 601 compares an originating IP address of the data packet with an IP address of the user computer contained in the memory 600, If the two addresses are the same, the AND gate 602 forwards the data packet. If they are different, it blocks the data packet. In addition to blocking the data packet, it may also cause the connection between the user computer and a host computer system to terminate,

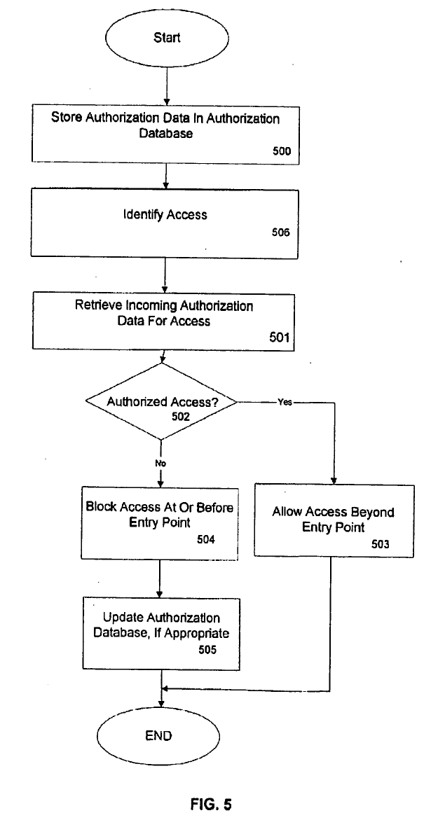

FIG. 5 is used to explain one aspect of the operation of a preferred embodiment of an access control system. At step 500, an IP address assigned to a user computer is stored in the memory of the access control system. If the IP address of the user computer changes periodically this step needs to be repeated whenever a new IP address is assigned to the user computer. The step 500 typically occurs when a connection between the user computer and a host computer system is established and the host computer system assigns an IP address to the user computer. If a permanent IP address is assigned to the user computer, this step may need to be executed only once.

At steps 501 and 502, an originating IP address of a data packet received from the user computer is compared with the IP address of the user computer stored in the memory. If the two IP addresses are the same, the data packet is sent to a network, which typically is the Internet, at step 503. More specifically, the access control system may forward the data packet to an access server of a host computer system for forwarding to the Internet. If the two IP addresses do not match, the access control system causes a connection between the user computer and the host computer system to terminate at step 504. The access control system itself may cause the termination of the connection by electrically cutting of the connection between the user computer and the host computer system or by filtering, out data packets from the user computer. Alternatively, it may issue commands so that the host computer system would terminate the connection with the user computer. Other methods of terminating the connection between the user computer and the host computer system would be known to those skilled in the art and thus are within the scope of the present invention.

Upon the termination of the connection, the access control system may delete the IP address of the user computer from the memory at 505. The IP address of the user computer may also be deleted when the user computer terminates the connection with the host computer system,

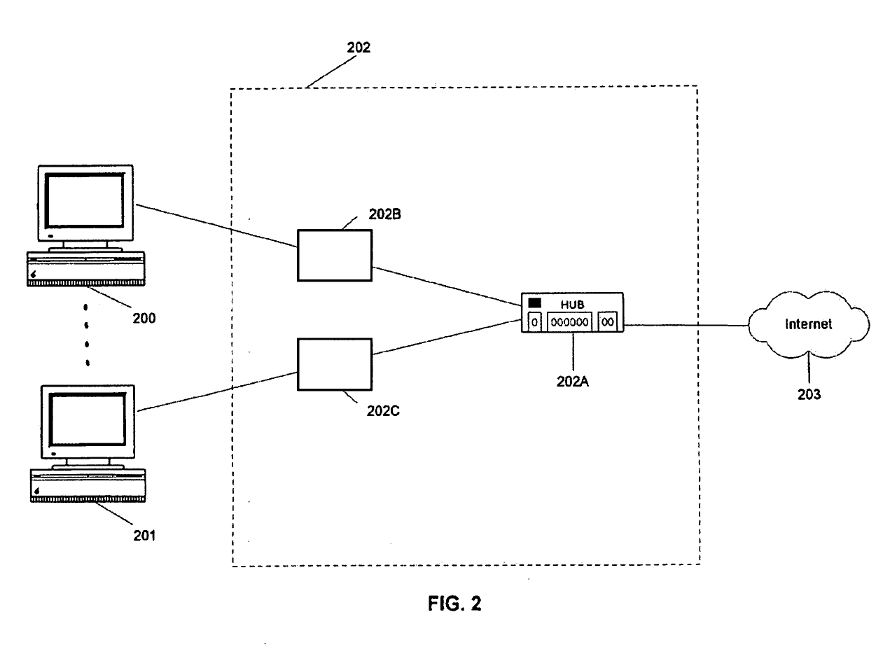

FIG. 2 depicts another embodiment of a secure network using access control systems of the present invention. A host computer system 202 includes a hub 202A and access control systems 202B and 202C. User computers 200 and 201 are connected to the hub 202A, for example, via a local area network. The hub 202A provides an access to the Internet 203. In other words, the user computers 200 and 201 access the Internet 203 via the hub 202A.

Kin FIG. 2, the access control systems 202B and 202C are located between the hub 202A and the user computers 20 and 201 respectively. They may also be implemented within the hub 202A or another system, such as a system provided by an Internet service provider, to which the hub 202A is connected, either as hardware or software. In either case, the access control systems should be implemented so that they would not be physically accessible to users without a proper authorization.

The access control systems 202B and 202C are responsible for data packets sent from the computers 200 and 201, respectively. For example, the access control system 202B would contain an IP address assigned to the user computer 200 and would terminate the connection between the user computer 200 and the hub 202A, when an originating IP address of a data packet from the user computer 200 does not match the stored IP address.

While the diagram depicts the network configured in a star topology with one hub (202A), other network configurations would be known to those skilled in tie an and are within the scope of this invention.

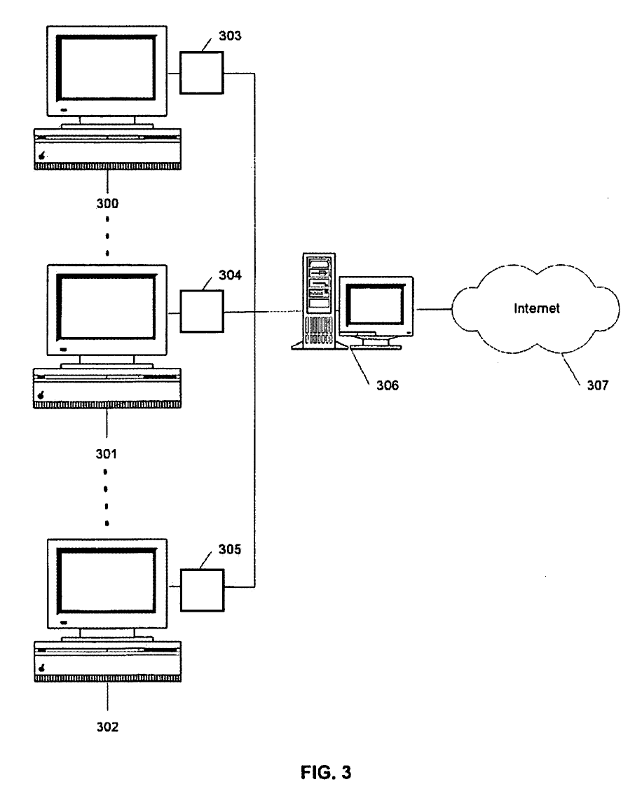

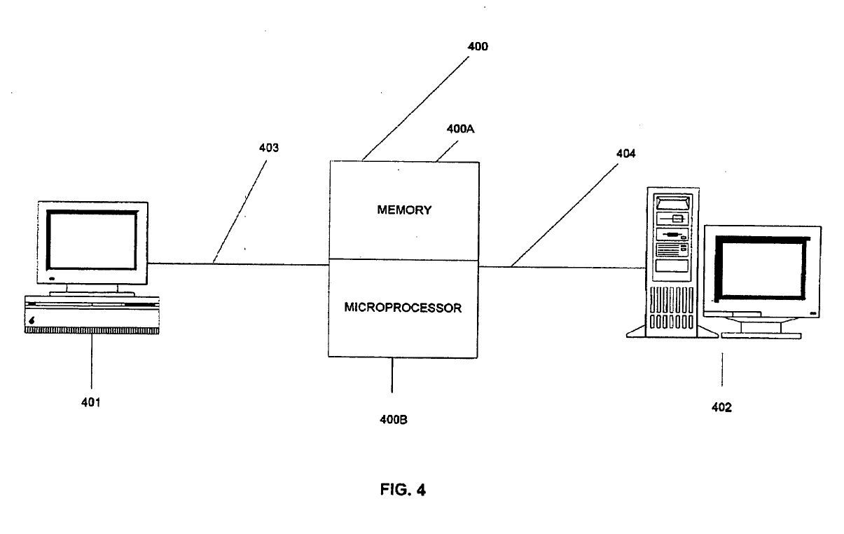

FIG. 3 depicts yet another implementation of a secure network using access control systems of the present invention. User computers 300, 301, and 302 access the Internet 307 though an access server 306. An Internet service provider may operate the access server 306. Alternatively, the access server 306 may be connected to a system operated by an Internet service provider. While this implementation depicts the user computers (300, 301, and 302) connected via a bus network, other network configurations such as a ring network may be used to implement the secure network of the present invention. In FIG. 3, access control systems 303, 304 and 305 reside outside the user computers 300, 301, and 302. They are located between each user computer and the access server 306. The access control systems 303, 304, and 305 may also be located within the user computers 300, 301, and 302. Alternatively, one or more access control system may be located within the access server 306.

Unlike the implementations in FIGS. 1 and 2, the access control systems 303, 304, and 305 in FIG. 3 are located near the user computers 300, 301, and 302. In other words, users have a physical access to them. Thus, it may be necessary to add capabilities to detect a physical tampering of the access control systems and to disable an access to the Internet upon a detection of any physical tampering.

Just like an access control system attached to a host computer system, the access control systems (303, 304, and 305) In FIG. 3 are programmed to terminate connections between the user Computers (300, 301, and 302) and the access server 306 when they receive a data packet whose originating IP address does not match the stored IP address. Each access control system is responsible for monitoring an originating IP address of each data packet sent from a user computer connected to it. For example, the access control system 303 checks an originating IP address of each data packet sent from the user computer 300. Upon detecting a mismatch between an originating IP address and the stored IP address, the access control system 303, for example, terminates the connection between the user computer 300 and the access server 306 to prevent a transmission of any subsequent data packet from the user computer to the Internet. This may be achieved, for example, by electrically cutting of the connection between the user computer 300 and the access server 306 or by filtering out data packets received from the user computer 300. Alternatively, the access control system 303 may issue appropriate commands to the user computer 300 or the access server 306 to terminate the connection

It will be apparent to those skilled in the art that various modifications and variations can be made in the method and system for preventing unauthorized access to a network of tile present invention without departing from the spirit or scope of the invention. Thus, it is intended that the present invention covers the modifications and variations of this invention provided they come within the scope of the appended claims and their equivalents.

1. An access control system for preventing an unauthorized access to a network via a user computer connected to the network, the system comprising;
a memory containing an IP address assigned to the user computer; and
a microprocessor programmed to terminate a connection between the user computer and the network when an originating IP address of a data packet received from the user computer does not match the IP address assigned to the user computer that is contained in the memory.

2. The access control system of claim 1, wherein the microprocessor is further programmed to delete the IP address of the user computer from the memory when the originating IP address of the data packet received from user computer does not match the IP address assigned to the user computer that is contained in the memory.

3. The access control system of claim 1, wherein the microprocessor is further programmed to update the IP address of the user computer contained in the memory.

4. The access control system of claim 1, wherein the memory is a part of the microprocessor.

5. An access control system for preventing an unauthorized access to a network via a user computer connected to the network through a host computer system, the system comprising:
a memory containing an IP address assigned to the user computer; and
a microprocessor programmed to terminate a connection between the user computer and the host computer system when an originating IP address of a data packet received from the user computer does not match the IP address assigned to the user computer that is contained in the memory,
wherein the access control system is located between the user computer and the host computer system.

6. The access control system of claim 5, wherein the microprocessor is further programmed to delete the IP address of the user computer from the memory when the originating IP address of the data packet received from the user computer does not match the IP address assigned to the user computer that is contained in the memory.

7. The access control system of claim 5, wherein the microprocessor is further programmed to update the IP address of the user computer contained in the memory.

8. The access control system of claim 5, wherein the memory is a part of the microprocessor.

9. (canceled)

10. (Canceled)

11. (Canceled)

12. (canceled)

13. (canceled)

14. (canceled)

15. (Canceled)

16. A secure network comprising:
a host computer system connected to the secure network;
an access control system connected to the host computer system and having a memory; and
a user computer connected to the host computer system capable of accessing the secure network through the host computer system,
wherein the memory of the access control system contains an IP address assigned to the user computer, and wherein the access control system is programmed to terminate a connection between the host computer system and the user computer when an originating IP address of a data packet sent from the user computer for transmission to a node in the secure network does not match the IP address of the user computer contained in the memory of the access control system.

17. The secure network of claim 16, wherein the user computer and the host computer system are connected via a Public Switched Telephone Network.

18. The secure network of claim 16, wherein the host computer system comprises an access server and a plurality of modems and wherein the access control system is located between the access server and the plurality of modems.

19. The secure network of claim 16, wherein the host computer system and the user computer are connected via a local area network.

20. A secure network comprising:
a user computer connected to the secure network; and
an access control system connected to the user computer and having a memory,
wherein the memory of the access control system contains an IP address assigned to the user computer, and wherein the access control system is programmed to deny the user computer an access to the secure network when an originating IP address of a data packet sent from the user computer for transmission to a node in the secure network does not match the IP address of the user computer contained in the memory of the access control system.

21. An access control system for preventing an unauthorized access to a network via a user computer connected to the network, the system comprising:
a memory containing an IP address assigned to the user computer; and
a comparator structure capable of terminating a connection between the user computer and the network when an originating IP address of a data packet received from the user computer does not match the IP address assigned to the user computer that is contained in the memory.

22. The access control system of claim 21, wherein a comparator structure comprises a microprocessor.

23. The access control system of claim 22, wherein the memory is a part of the microprocessor.
